(19) United States
(12) Patent Application Publication
(10) Pub. No.: US 2019/0232471 A1
(43) Pub. Date: Aug. 1, 2019

(54) IMPACT TOOL

(71) Applicant: DINO PAOLI S.R.L., Reggio Emilia (IT)

(72) Inventors: Patrizia PAOLI, Cadelbosco di Sopra (IT); Federico GALLONI, Reggio Emilia (IT); Paolo TASSIN, Vergato (IT)

(21) Appl. No.: 15/886,002

(22) Filed: Feb. 1, 2018

(51) Int. Cl. B25B 23/145; B25B 21/02

(52) U.S. Cl. CPC B25B 23/1453; B25B 21/02

(57) ABSTRACT

An impact tool includes a housing, a rotating hammer arranged in the housing and rotatable by a motor, and a rotating anvil arranged in the housing and rotatable by the hammer by a series of impacts. An output shaft has a proximal end fixed to the anvil and a distal end protruding from the housing and ending with a fitting element for removable connection with an external mechanical adapter. A sensor unit includes a rotational torque sensor for detecting a torque of the shaft. The torque sensor includes at least one extensometric transducer fixed to an outer surface of a cylindrical portion of the distal end adjacent to the fitting element to detect a deformation signal that is proportional to a deformation of the outer surface when the shaft is rotated and indicative of the torque. The sensor unit further includes a rotating electronic module connected to the extensometric transducer and includes a microprocessor for conditioning the deformation signal, the rotating electronic module being shaped in such a manner to surround the cylindrical portion and mounted to rotate integrally with the rotating output shaft.

### BACKGROUND OF THE INVENTION

The invention relates to an impact tool, in particular an impact wrench.

The present invention can be used for tightening and loosening a bolt on a threaded hub of a wheel or a nut on a threaded pin provided in a wheel, for example in order to rapidly change the wheels of a vehicle during a race.

The invention refers to an impact tool in which: a rotating mass, for example a hammer, that acts as a flywheel to store mechanical energy, is rotated by a motor, in particular of pneumatic type; a rotating shaft is fixed to an anvil rotated by the hammer by a series of impacts, for example one impact for each revolution; the connecting mechanism between the hammer and the anvil comprises a clutch that, after each impact, leaves the hammer free to rotate again and which can be driven, for example, by a cam system. In use, a bush is connected removably to the rotating shaft.

The invention refers to an impact tool having a torque sensor operationally associated with the output shaft.

The use of a pneumatic impact wrench for fitting and removing wheels to and from a motor vehicle is known, in which the tightness of the bolt that locks the wheel to the hub (generally made of hardened and tempered steel) must be safe and reliable, even when the stress transmitted from the wheels to the hub is high, as occurs in a vehicle competing in a car or motorcycle race.

It is thus not only necessary that the wrench rotate fast, but that it also ensures appropriate tightness, with known torque, so as not to damage the bolt, to ensure the maintenance of the coupling between bolt and hub in all conditions, for example during a competition.

In addition, it is desirable to control the tightening for each bolt of a wheel and obtain the number of appropriate tightening operations performed.

From patent publication EP2535139 B1, for example, measuring the torsional moment on the output shaft of a pneumatic impact tool, by using a torque sensor of magnetic type, and stopping the tool when a threshold value of the detected torque is reached is known. The torque sensor comprises at least two coils wound around the output shaft of the tool, in which one coil (generator coil) operates as a magnetic field generator and the other coil (sensor coil) operates as a magnetic field sensor. The generator coil is connected to a first electronic module that comprises a driver and a signal generator. The sensor coil is connected to a second electronic module to condition the analogue signal supplied by the sensor coil and process the signal so as to provide an output signal. The torque sensor is provided with an electric energy supply, for example a battery.

A drawback of pneumatic impact tools that are known from the prior art is that the output signal is affected by significant errors. In fact, a magnetic torque sensor like the one disclosed above is extremely sensitive to temperature, which in the application operating conditions of the aforesaid pneumatic tools can vary significantly.

Another drawback of pneumatic impact tools that are known from the prior art is that the magnetic torque sensor has a short service life because of the mechanical and thermal stress of the application operating conditions of the aforesaid pneumatic tools.

### SUMMARY OF THE INVENTION

An object of the invention is to improve known impact tools.

Another object of the invention is to provide an impact tool with a monitoring system for monitoring the action exerted by the tool on a plurality of screw-locking members.

A further object of the invention is to make an impact tool with a monitoring system for monitoring the action exerted by the tool on a plurality of screw-locking members having relatively reduced dimensions and weight.

A still further object of the invention is to provide an impact tool that is simple to build and is very reliable.

The objects mentioned above and still others are achieved with an impact tool according to one or more of the claims set out below.

Owing to a system for monitoring the torque applied to the output shaft, the impact tool according to the invention determines with precision and reliability whether and when all the screw-locking members have been screwed to the desired tightening force.

The system for monitoring the torque of the impact tool according to the invention is configured to be suitable for use in significantly critical situations, such as for example in the ambit of an impact tool that works with great and complex dynamic stress.

### BRIEF DESCRIPTION OF THE DRAWINGS

The invention can be better understood and implemented with reference to the attached drawings that illustrate an embodiment thereof by way of non-limiting example, in which:

FIG. 1 is a side view of an impact tool according to the present invention;

FIG. 2 is a view like that of FIG. 1 in which part of the housing of the impact tool of FIG. 1 has been removed to highlight components thereof that would not be otherwise visible;

FIG. 3 shows a sensor unit associated with a portion of shaft of the impact tool according to the invention;

FIG. 4 is a perspective view of a phonic wheel mounted in the impact tool of FIG. 1;

FIG. 5 is a bottom view of a partial section V-V of FIG. 1 of the impact tool of FIG. 1;

FIG. 6 shows a trend of the torsional moment of an output shaft of the impact tool of FIG. 1 through a succession of impacts, when the impact tool is used to screw five screw-locking members.

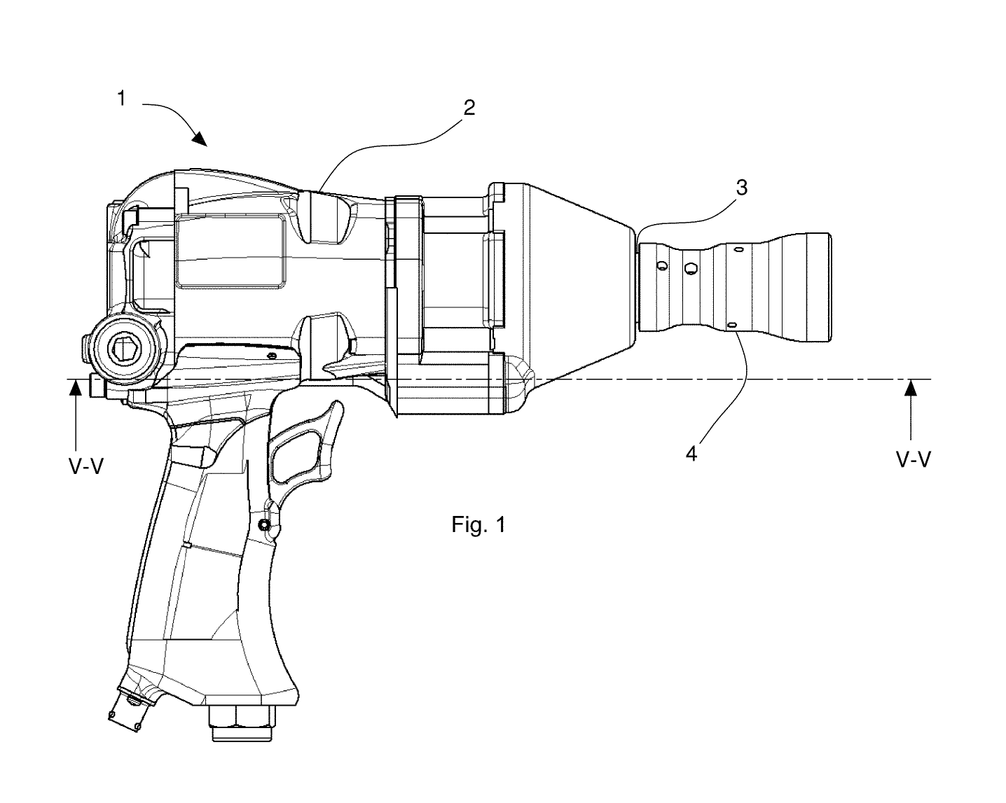

### DETAILED DESCRIPTION

With reference to the aforesaid Figures, overall with 1 an impact tool has been indicated that, in the specific case, is an impact wrench that is usable, for example, for fitting and removing wheels of vehicles, in particular racing cars or motorcycles.

The impact tool 1 comprises a housing 2 that houses internally a rotating hammer (not shown in the Figures) rotated by a motor (not shown in the Figures). In the case in point, the motor is of pneumatic type. The rotating hammer operates as a flywheel for accumulating mechanical energy.

The impact tool 1 comprises a rotating anvil (not shown in the Figures) that is arranged in the housing 2 and rotated by the rotating hammer by a series of impacts. The rotating hammer and the anvil are coupled by a coupling system of known type and which is not illustrated in the Figures, which may comprise a front clutch driven by a cam system that periodically connects and disconnects (for example once a revolution) the rotating hammer and the anvil from one another. The coupling between the rotating hammer and the anvil can be made in such a manner that at each revolution the rotating hammer couples for a short period of time (for a fraction of a revolution) with the anvil, giving the anvil a rotation pulse with a high torque impact.

The impact tool 1 further comprises an output shaft 3 that rotates around a rotation axis rotating integral with the anvil. The output shaft 3 may have, in the specific case, an end proximal to the anvil and a distal end that may, as in this case, protrude from the housing 2. The distal end may end with a fitting element, not shown in the Figures, for removable connection with an external device. The fitting element may comprise, for example, a square fitting. The external device may comprise, for example, a bush or mechanical adapter 4, that is suitable for connecting the fitting element to a screw member, not shown in the Figures (for example with a nut for locking a wheel on a hub).

In use, when the operator activates the impact tool, for example by pressing a start button, a supply of compressed air drives the pneumatic motor that commands the rotating hammer that, by hitting the rotating anvil repeatedly, rotates the output shaft 3 applied to the external device (screw coupling member). In the case of a wrench, a screw coupling member will be screwed (or unscrewed) by the intermittent action of a succession of torsional impacts. In initial impacts, the rotations of the output shaft 3 will, for each impact, be relatively high and will then decrease as the final situation approaches in which the external device (for example the screw coupling member) has been rotated (screwed) to the desired tightness.

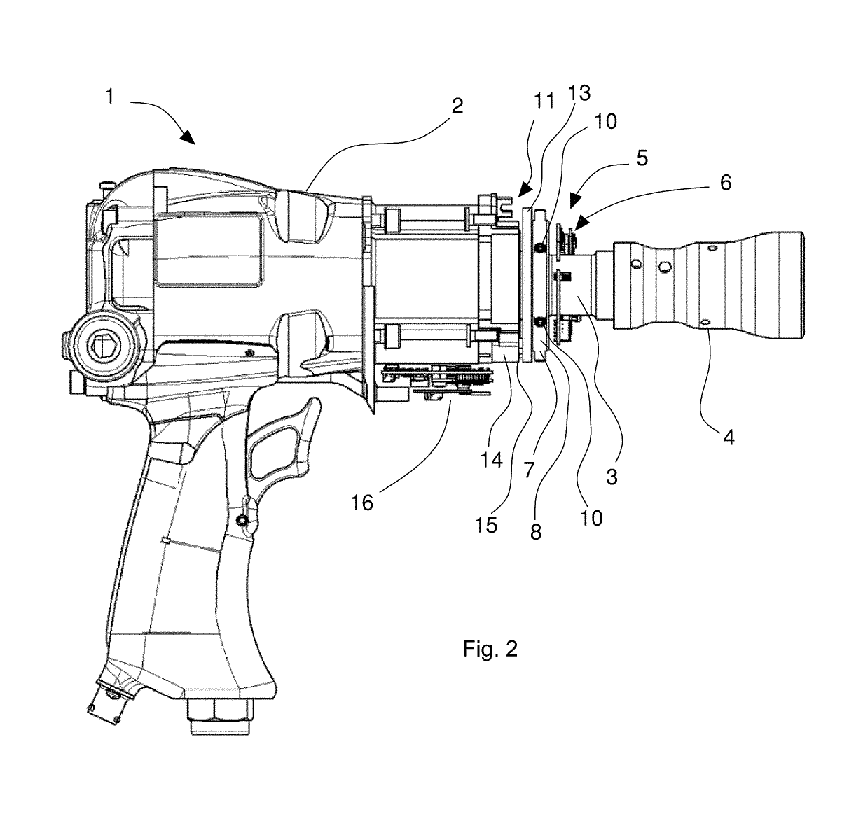

With reference in particular to FIG. 2, the impact tool 1 further comprises a sensor unit 5 associated with the output shaft 3 and arranged for obtaining a torsional moment of the output shaft 3 during use, i.e. when the latter is rotated by the anvil-hammer coupling.

The sensor unit 5 comprises a torque sensor mounted on the output shaft 3 at a cylindrical end portion 17 of the distal end of the output shaft 3 to measure the aforesaid torsional moment of the output shaft 3. It has been found that the end portion 17, that is interposed axially between the fitting element and the zone of the housing 2 from which the distal end protrudes, is the most suitable portion of shaft for positioning the torque sensor, in order to determine precisely the torsional moment that the impact tool 1 actually applies to the mechanical adapter 4 and thus to the screw member.

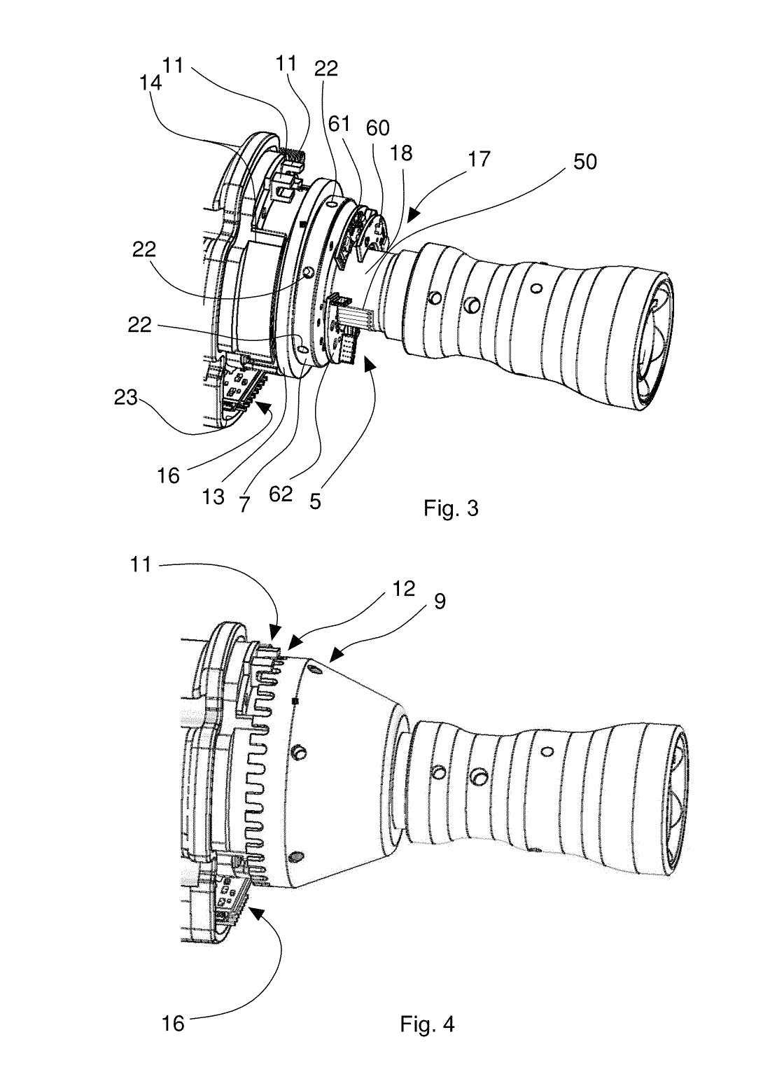

With reference in particular to FIG. 3, the torque sensor comprises an extensometric transducer 50, fixed to a portion of outer surface 18 of the cylindrical end portion 17 of the output shaft 3 and arranged for measuring a deformation of the outer surface 18. In particular, the extensometric transducer 50 can be glued onto said outer surface 18.

The extensometric transducer 50 can be for example of resistive type, i.e. may comprise one or more resistances. One or more of these resistances may be of variable type.

In use, the cylindrical end portion 17 of the output shaft 3 and, as a result, the extensometric transducer 50 to which it is fixed, is subjected to a deformation that is proportional to the torque force applied to the output shaft 3 during use. The extensometric transducer 50 transduces the torsional deformation into a deformation signal, of analogue type, which is proportional to the deformation applied to the outer surface of the shaft 3 to which it is fixed. When the extensometric transducer 50 is of resistive type, the torsional deformation causes a variation in electric resistance, which in turn causes a variation in the deformation signal.

The deformation signal can be for example a current or voltage value that is for example measurable by a bridge circuit with which the extensometric transducer 50 is provided, for example a Wheatstone bridge. In particular, the extensometric transducer 50 comprises a double semi-Wheatstone bridge. This enables improved conditioning of the deformation signal to be obtained, for example it enables the deformation signal to be amplified.

By measuring the surface deformation to which the output shaft 3 is subjected by the extensometric transducer 50, the torque sensor thus enables the torsional moment to be obtained to which the cylindrical end portion 17 of the output shaft 3 is subjected in use.

The sensor unit 5 further comprises a rotating electronic module 6 arranged for processing the deformation signal indicating the deformation detected by the torque sensor.

The rotating electronic module 6 is shaped in such a manner as to surround the cylindrical portion 17 of the output shaft 3 and is mounted in such a manner as to rotate integrally with the rotating output shaft 3.

The aforesaid rotating electronic module 6 is provided with a microprocessor to carry out conditioning of the deformation signal. The microprocessor receives the input deformation signal, processes the signal and outputs a conditioned signal that carries the information relating to the deformation. Owing to the microprocessor, the sensor unit 5 thus acts as an active sensor.

A low absorption microprocessor is chosen so that it consumes a minimum quantity of energy.

The components of the rotating electronic module 6 are chosen in such a manner as not to generate induced current of piezoelectric type. This is particularly useful in applications in which the output shaft 3 rotates at high angular speeds, for example 10,000 RPM-13,0000 RPM or higher and works as an impact hammer with very great and alternating mechanical stresses.

Below, with reference in particular to FIG. 3, an embodiment is disclosed of the electronic module 6 purely by way of non-limiting example. The rotating electronic module 6 comprises a first electronic board 60 on which the microprocessor is mounted to process the deformation signal and a second electronic board 61 that is suitable for permitting electrical supply of the sensor unit 5 and transmission of the conditioned signal. The first electronic board 60 may have a substantially plan shape like a portion of circular ring. The second electronic board 61 may also have a substantially plan shape like a portion of circular ring.

The first electronic board 60 and the second electronic board 61 can be mounted on one another and connected by an elastic connecting element. In addition or alternatively it is possible to connect the first electronic board 60 and the second electronic board 61 by inserting between them a damping material to attenuate vibrations that occur during use of the impact tool and transmitted during use, for example silicone.

The rotating electronic module 6 may further comprise a third electronic board 62 arranged for being connected on one side to the extensometric transducer 50 and on the other side to the second electronic board 61. A wire connecting element can be provided of known type to make the connection between the third electronic board 62 and the second electronic board 61, that in FIG. 3 have been omitted for the sake of clarity. Also the third electronic board 62 may have a substantially plan shape like a portion of circular ring.

The rotating electronic module 6 may comprise a coating element arranged for protecting the electronic components with which it is provided. In particular, the coating element enables vibrations, accelerations and oscillations to which the rotating electronic module 6 is subjected during rotation integral with the output shaft 3 during use of the impact tool 1 to be attenuated.

The coating element may comprise, or be made of, a damping material, for example silicone. In particular, the coating element can be provided on one or more of the electronic boards disclosed above.

The impact tool 1 further comprises a flanged support, not shown in the Figures, arranged for further damping the vibrations to which the rotating electronic module 6 is subjected. For this purpose, the flanged support is made of a damping material that is suitable for damping the vibrations transmitted during operation of the impact tool 1.

In the following description, the term “to the rear” or “rear” means an element arranged to the left of another element, taking as an initial reference the distal end of the output shaft 3 of FIG. 2.

The flanged support is mounted removably on the output shaft 3 so as to rotate integrally with the latter when rotated and to be able to be mounted to the rear of the rotating electronic module 6.

The impact tool 1 further comprises an annular support element 7, arranged for supporting the sensor unit 5.

The annular support element 7 can be a flange.

The annular support element 7 is mounted on the output shaft 3 so as to rotate integrally with the latter when rotated and can be mounted to the rear of the flanged support.

The rotating electronic module 6 is connected by a connecting element of known type, comprising for example a screw, to the annular support element 7. In this manner, the rotating electronic module 6 rotates integrally with the output shaft 3 when the latter is rotated. The annular support element 7 can be made of light alloy, in particular an aluminum alloy.

The impact tool 1 further comprises an angular position sensor device, arranged for measuring an angular shift of the output shaft 3 around a rotation axis thereof when the output shaft 3 is rotated. The rotation angle of the output shaft 3 around a rotation axis thereof corresponds to the actual rotation angle of the external device rotated by the impact tool 1.

The angular position sensor device may comprise an encoder, in particular an incremental encoder.

With reference to FIG. 3, the angular position sensor device may comprise a phonic wheel 9, shown in FIG. 4, which is substantially bell-shaped, mounted integrally with the output shaft 3. In particular, along an outer annular surface 8 of the annular support element 7 openings 22 can be obtained that are intended for housing fixing screws or grub screws 10 that enable the phonic wheel 9 to be fixed to the output shaft 3.

The angular position sensor device comprises at least one photocell 11 mounted so as not to rotate when the output shaft 3 is rotated. In other words, the photocell 11 is fixed with respect to the output shaft 3.

In the embodiment shown in the drawings, a pair of photocells 11 is provided to be able to identify the rotation direction of the output shaft 3 and the corresponding shift.

The phonic wheel 9 is mounted in such a manner that a notched edge 12 thereof faces the photocell 11 or the pair of photocells 11.

In this manner, in use, the photocells 11 detect a light source, outputting an output signal having a current intensity or a potential difference that is proportional to the intensity of the detected radiation. The light emission may have a wavelength of more than 900 nm. In particular, the photocells 11 detect the alternation of teeth and perforations of the notched edge 12 in the form of variations in light intensity. The teeth and perforations are associated with angular rotation sectors of the output shaft 3 and the width thereof is an index of the angular resolution of the angular position sensor device.

Owing to the phonic wheel 9 and the photocell 11 the angular position sensor device makes an encoder. When a pair of photocells 11 is provided, the angular position sensor device makes an incremental encoder.

The angular position sensor device comprises an opto-electronic module arranged for receiving the light signal that is proportional to the variations in light intensity detected by the pair of photocells 11 due to the alternation of teeth and perforations of the notched edge 12, and transforming the variations in light intensity into variations in intensity of an electric parameter, for example electric current or potential difference.

Owing to the angular position sensor device, it is possible to discern the rotation direction of the output shaft 3 during use of the impact tool 1. It is further possible to measure the angular shift of the output shaft 3 over time and thus detect whether the angular shift varies in an undesirable manner, for example because of incorrect tightening, as will be illustrated better below.

The impact tool 1 further comprises an annular supply and communication element 13 arranged for enabling the sensor unit 5 to be supplied electrically and communication with the rotating electronic module 6 in order to be able to receive the conditioned signal.

The annular supply and communication element 13 is mounted on the cylindrical portion 17 so as to rotate integrally with the shaft 3.

In particular, the annular supply and communication element 13 is mounted to the rear of the annular support element 7.

The annular supply and communication element 13 has substantially the shape of a disk in which a central hole is obtained so as to be mounted around the output shaft 3.

The annular supply and communication element 13 is made of an insulating material, in particular polymeric material.

On a face of the annular supply and communication element 13, in particular on the face opposite the annular support element 7, an electric track 19 is made, for example deposited, that is made of an electrically conductive material, for example copper.

The electric track 19 can be of annular shape.

The electric track 19 can be provided on an outer ring of the aforesaid face of the annular supply and communication element 13.

The impact tool 1 further comprises, a brush holder 14 mounted to the rear of the annular supply and communication element 13.

The brush holder 14 is stationary (or provided with relative motion) with respect to the electric track 19 when the output shaft 3 is rotated.

The brush holder 14 comprises at least one housing 20 that is suitable for housing a respective sliding conductor 15, the so-called brush. The sliding conductor 15 is made of a conductive material, for example comprising carbon and graphite or metallic graphite. The sliding conductor 15 may have a square shape.

The sliding conductor 15 may comprise an elastic element 24 connecting to the housing 20.

In use, the sliding conductor 15 is so mounted as to face and contact the electric track 19. In particular, the sliding conductor 15 comprises a protruding portion 21 that protrudes beyond the housing 20, which is provided with a contact surface that is suitable for contacting a portion of the aforesaid electric track 19. In fact, the sliding conductor 15 is placed in sliding contact with the aforesaid electric track 19 so as to connect electrically the electric track 19 and the holder 14.

The electric track 19 is connected to the rotating electronic module 6. In particular, the electric track 19 is connected to the second board 61 of the rotating electronic module 6, when provided. In this manner it is possible to supply the sensor unit 5 electrically and, in particular, the torque sensor.

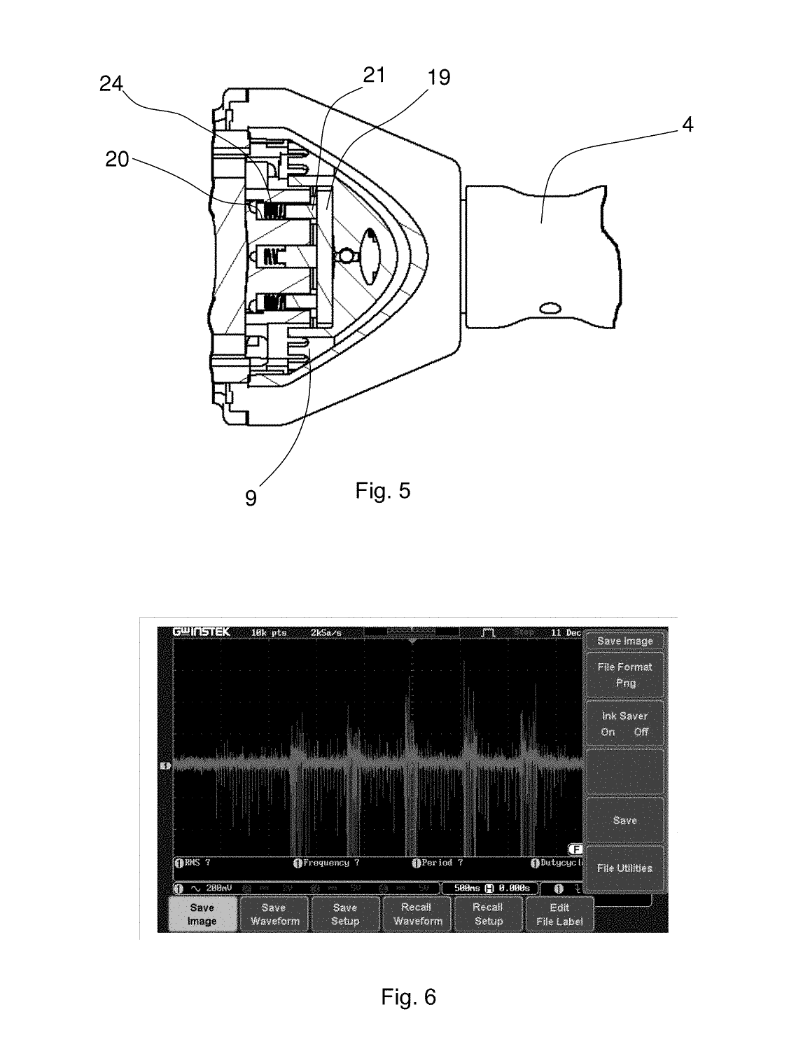

It is possible to provide on the brush holder 14 more than once sliding conductor 15 of the type disclosed above, for example three as in the embodiment shown in FIG. 5, that in use contact the electric track 19 simultaneously. Correspondingly, respective housings 20 will be provided in the brush holder 14. The housings 20 and accordingly, the sliding conductors 15, can be spaced angularly, for example along an external circular ring of the brush holder 14.

Providing a plurality of sliding conductors 15 enables the electric contact between the electric track 19 and brush holder 14 to be maintained even if a single sliding conductor 15 becomes worn, improving the reliability of the electrical connection and, consequently, the supply of the sensor unit 5 and the transmission of the conditioned signal.

With reference in particular to FIGS. 3 and 4, the impact tool 1 further comprises, a fixed electronic module 16 arranged for receiving the conditioned signal.

The fixed electronic module 16 is connected electronically to each sliding conductor 15 to be supplied by the sliding contact made by the latter with the electric track 19 and to receive the conditioned signal from the sliding conductors 15.

Owing to the electrical connection of the sliding conductors 15 on the electric track 19, a communication is in fact possible between the rotating electronic module 6 of the sensor unit 5 and the fixed electronic module 16, which can thus receive the conditioned signal coming from the sensor unit 5.

The communication between the fixed electronic module 16 and the rotating electronic module 6 can be implemented by frequency modulation, for example using radio frequency. In particular, the frequency modulation can be of FSK type. For this purpose, the fixed electronic module 16 and the rotating electronic module 6 comprise electronic and circuit components, of known type, indispensable for the operation thereof and for making the aforesaid communication.

The extreme low energy active part of the sensor unit 5 that is supplied by frequency modulation is provided with smart firmware that performs self-calibration of the torque sensor and recovers the mechanical deformations that there may be during operation of the impact tool 1. In particular, at each start of the impact tool 1 and before rotating the output shaft 3, the microprocessor of the sensor unit 5 performs a zero off-set correction, for example by adding a voltage variation detected at the moment to obtain a balanced Wheatstone bridge. The voltage variations may occur following assembly of the extensometric transducer 50 of the impact tool 1 or following wear to the components of the sensor unit 5.

The fixed electronic module 16 is further arranged for enabling the analog signal coming from the opto-electronic module to be received. For this purpose, the fixed electronic module 16 is connected to the opto-electronic module by, for example, a cable connection.

The fixed electronic module 16 is fixed (or provided with corresponding motion) with respect to the rotating electronic module 6 when the output shaft 3 is rotated.

The fixed electronic module 16 can be mounted in a lower recess 23 made in the housing 2 of the impact tool 1.

Owing to the electric track 19 and to the sliding conductors 15, a supply of the torque sensor on the output shaft 3 and a communication between the rotating electronic module 6 and the fixed electronic module 16 is possible in such a manner that the latter can receive the conditioned signal coming from the sensor unit 5, which has been opportunely frequency modulated.

In an alternative embodiment, the communication between the fixed electronic module 16 and the rotating electronic module 6 is of wireless type, i.e. by electromagnetic radiation, for example by radio waves. In this case, the two modules comprise electronic and circuit components of known type, such as for example antennas, that are suitable for making a communication between the two modules. By the aforesaid components it is possible that both the electrical supply of the sensor unit 5 and the transmission of the conditioned signal from the rotating electronic module to the fixed electronic module occur by the wireless communication disclosed above.

In one still alternative embodiment, it is possible that the supply of the sensor unit 5 is wired (wired) through the sliding conductors 15 and the communication between the fixed electronic module 16 and rotating electronic module 6 is radiated (wireless).

In use, the fixed electronic module 16 processes the conditioned signal and the analog signal coming from the opto-electronic module to enable the signals to be transmitted to a control unit, for example remotely.

The control unit can be connected by cable to the fixed electronic module 16.

Alternatively, the control unit and the impact tool 1 can communicate between a data transmission network of the CAN-BUS type.

The control unit is configured for acquiring the conditioned signal coming from the torque sensor unit 5, which signal indicates the torque on the output shaft 3 during operation, and thus for determining the torsional moment to which the output shaft 3 is subjected during tightening of a bolt.

The control unit is further configured for acquiring the analog signal coming from the angular position sensor device, and thus determine an operating mode of the impact tool 1. For example, when the impact tool 1 is a wrench, the control unit is able to detect when the latter is driven to tighten or loosen.

Further, the degrees of rotation of the output shaft 3 are sent to the control unit in order to assign to each torque value a degree of rotation of the output shaft 3 to determine incorrect tightening, as will be explained better below.

The control unit comprises a signal processing device that analyzes the signals received from the control unit and can cause a desired situation to be reached, i.e. the tightening of a bolt. The desired situation can be reached, for example, when the torque becomes greater than or the same as a threshold maximum torque value that is preset and programmable.

Naturally, the threshold value can be comprised within a tolerance range of threshold values.

The signal processing device can correlate the conditioned torque signal with the analog signal coming from the angular position sensor device, with reference to the same time interval, in order to determine the reaching of the desired situation, i.e. tightening of the bolt. The desired situation can be reached if to the torque that is greater than or the same as the aforesaid threshold value corresponds an angular shift in the preset time of the output shaft 3.

In FIG. 6 the pattern is shown over time of the signal coming from the torque sensor during tightening of 5 nuts.

The signal processing device can obtain monitoring data associated with the processed signals. The aforesaid monitoring data can be displayed on a display device, for example a monitor.

The monitoring data can comprise tightening torque values of each nut, in order to establish whether tightening is to be considered to be suitable or not.

The control unit can also acquire a maximum rotation speed of the output shaft 3 of the impact tool 1 during tightening of each nut.

The signal processing device can be programmed to acquire the signal indicating torque and the signal indicating the angular position only in a determined acquisition time interval. In particular, the control unit can be programmed to receive a minimum threshold value of the torque (for example a value that is set by the operator and is programmable) and to acquire the signal indicating the torque over an interval of time that has as lower bound the moment at which the aforesaid minimum threshold value of the torque is reached.

The upper bound can be a value that is set by the operator or is programmable. For example, the acquisition interval can be 15 seconds. The interval between the aforesaid lower and upper bound defines the duration of the acquisition time interval.

The signal processing device is thus programmed to limit the time of acquisition of the data concerning torque. The torque values that, during the same hammer-anvil impact cycle, although exceeding the minimum threshold value of the torque, are detected after the interval of time defined by the maximum value, will not be considered by the processing device.

The signal processing device can be programmed for setting the aforesaid lower bound when at the same time the minimum torque value is exceeded and another condition has occurred. The other condition can be, for example, that a photocell or camera have detected the transit of the vehicle onto or from which one or more wheels have to be tightened/loosened.

The impact tool 1 disclosed above is a wrench, which is usable in particular for changing the wheels of a vehicle (for example in car races or in tire shops), or in the building industry or in other industrial sectors. It is possible to apply the teachings disclose above to any other type of impact tool with rotating hammer-anvil.

1. An impact tool comprising:
a housing;
a rotating hammer arranged in said housing and rotatable by a motor;
a rotating anvil arranged in said housing and rotatable by said hammer by a series of impacts;
an output shaft rotating around a rotation axis, said shaft having a proximal end fixed to said anvil and a distal end protruding from said housing, said distal end ending with a fitting element for removable connection with an external mechanical adapter;
a sensor unit comprising a rotational torque sensor to detect a torque of said shaft;
wherein said torque sensor comprises at least one extensometric transducer fixed to an outer surface of a cylindrical portion of said distal end adjacent to said fitting element to detect a deformation signal that is proportional to a deformation of said outer surface when said shaft is rotated and indicative of said torque;
and in which said sensor unit further comprises a rotating electronic module connected to said extensometric transducer and provided with a microprocessor for conditioning said deformation signal, said rotating electronic module being shaped so as to surround said cylindrical portion and being mounted so as to rotate integrally with said rotating output shaft.

2. An impact tool according to claim 1, wherein said rotating electronic module comprises a first electronic board on which said microprocessor is mounted to process said deformation signal, said first electronic board being substantially shaped in a plan view as a portion of circular ring.

3. An impact tool according to claim 2, wherein said rotating electronic module further comprises a second electronic board that is suitable for connecting said torque sensor with an electric track, said second electronic board being substantially shaped in a plan view as a portion of circular ring.

4. An impact tool according to claim 3, wherein said rotating electronic module further comprises a third electronic board arranged for being connected on one side to said extensometric transducer and on the other side to said second electronic board, said third electronic board being substantially shaped in a plan view as a portion of circular ring.

5. An impact tool according to claim 3, and further comprising at least one sliding conductor mounted fixed with respect to said rotating output shaft arranged for contacting at least one portion of said electric track connected to said rotating electronic module in order to supply said torque sensor with electric power and enable said conditioned signal to be transmitted.

6. An impact tool according to claim 5, and further comprising a brush holder in which at least one housing is obtained that is arranged for housing said sliding conductor, said sliding conductor comprising a protruding portion that protrudes beyond said housing and is provided with a contact surface suitable for contacting a portion of said electric track to make a sliding contact.

7. An impact tool according to claim 1, and further comprising an angular position sensor device arranged for detecting an angular shift of said rotating output shaft around said rotation axis.

8. An impact tool according to claim 7, wherein said angular position sensor device comprises a phonic wheel mounted integrally with said rotating output shaft and at least one photocell mounted fixed with respect to said rotating output shaft, said phonic wheel and said at least one photocell being reciprocally mounted such that a notched edge of said phonic wheel faces said at least one photocell so that said at least one photocell detects a light signal that is proportional to variations in light intensity that are due to the alternating of notches and of perforations of said notched edge.

9. An impact tool according to claim 8, wherein said angular position sensor device comprises an opto-electronic module arranged for transforming said variations in light intensity into variations of an electrical parameter and outputting an analog signal indicating said variations in light intensity.

10. An impact tool according to claim 9, and further comprising a fixed electronic module arranged for receiving said conditioned signal and said analog signal indicating said variations in light intensity and processing them and enabling the signals to be transmitted to a control unit.

11. An impact tool according to claim 10, wherein said fixed electronic module is connected to said opto-electronic module and to said electric track.

12. An impact tool according to claim 10, wherein said fixed electronic module and said rotating electronic module comprise electronic devices for making a wireless communication configured for supplying electric power to said torque sensor and enabling said conditioned signal to be transmitted from said rotating electronic module to said fixed electronic module by electromagnetic irradiation.
